(19) United States
(12) Patent Application Publication
(10) Pub. No.: US 2022/0332890 A1
(43) Pub. Date: Oct. 20, 2022

(54) Melt Flowable Polyamide Composition for Shaped Articles

(71) Applicant: BASF SE, Ludwigshafen am Rhein (DE)

(72) Inventors: Mohammad MEYSAMI, Budd Lake, NJ (US); Stephen J HANLEY, Budd Lake, NJ (US); Patrick SPIES, Ludwigshafen (DE); Mohammad MONIRUZZAMAN, Budd Lake, NJ (US)

(21) Appl. No.: 17/754,080

(22) PCT Filed: Sep. 10, 2020
(86) PCT No.: PCT/EP2020/075374

§ 371 Date: Mar. 23, 2022

Related U.S. Application Data
(60) Provisional application No. 62/903,969, filed on Sep. 23, 2019.

(30) Foreign Application Priority Data
Dec. 16, 2019 (EP) 19216458.0

(51) Int. Cl. C08G 69/26; C08G 69/48; C08K 5/092; C08K 7/14; B29C 48/00

(52) U.S. Cl. CPC C08G 69/26; C08G 69/48; C08K 5/092; C08K 7/14; B29C 48/022; B29K 2077/00

(57) ABSTRACT

Described herein is a melt flowable polyamide composition for shaped articles, which may include thin wall connectors such as electrical connectors.

### FIELD OF INVENTION

The present invention relates to a melt flowable polyamide composition for shaped articles, particularly thin wall connectors such as electrical connectors.

### BACKGROUND OF THE INVENTION

Polyamide compositions comprising various additives can be converted by molding, injection molding, extrusion or drawing to articles of multiple forms such as, but not limited to, plastic component, threads and fibers.

The polyamides can be modified, particularly to polyamides containing units of the type obtained by reacting a diacid with a diamine, modified with a multifunctional compound. Finished articles shaped from these polyamides or from compositions based on these polyamides have been known to have excellent mechanical properties and also a very good surface aspect.

U.S. Pat. No. 6,864,354 B2 discloses a modified polyamide. The modified polyamide contains repeating units of the type obtained by polycondensing a dicarboxylic acid with a diamine, the thermomechanical properties of which are satisfactory, in particular impact strength, and which has a high melt flow index. Articles obtained using the modified polyamide have surfaces showing good reflectivity, thereby rendering them suitable for manufacturing motor vehicle parts, for example bodywork parts, for manufacturing parts of sports and leisure articles, for example roller skates and winter sports fastening and shoes.

U.S. Pat. No. 8,097,684 B2 describes thermoplastic compositions containing a polyamide and/or polyester matrix and a variety of additives. The thermoplastic composition is characterized by fluidity or rheological behaviour compatible with the forming process, thereby rendering them suitable to be able to be conveyed and handled easily. The components molded from these thermoplastic compositions have an improved surface appearance.

U.S. Pat. No. 7,931,959 B2 describes polyamide composition comprising fibers that have improved tensile strength, and also an increased melt flow. In particular, polyamide compositions comprising fibers which have a good alignment with respect to the direction of the injection at the surface and also at the core of the articles formed, especially by injection molding, are described here. The good alignment of the fibers makes it possible to obtain articles having good mechanical properties, especially a very good tensile strength.

Polyamide compositions which are melt flowable, are known in the art. However, processing these compositions requires high injection pressure. A high injection pressure results in an increase in cycle time and a reduction in productivity. Moreover, the high injection pressure also results in an increase in tool wear and maintenance. Further, these polyamide compositions require larger press size to obtain the shaped articles.

Additionally, the state-of-the-art polymers have been obtained using the conventional polymerisation technique, which results in mostly star shaped configuration in the polymer due to large residence time. For instance, U.S. Pat. No. 6,525,166 B1 describes polyamide comprising macromolecular chains exhibiting a star configuration.

It is, therefore, an object of the presently claimed invention to provide a shaped article comprising a polyamide composition which is melt flowable, can be processed at lower injection pressure, thereby resulting in a reduced cycle time and press size, increase in productivity and reduction in tool wear and maintenance. Another object is to provide a polyamide composition which has acceptable mechanical properties and reduced cooling temperature, which further reduces the cycle time and adds up to the productivity.

### SUMMARY OF THE INVENTION

Surprisingly, it has been found that the above objects are met by the present invention as described hereinbelow and as reflected in the claims.

Accordingly, in one aspect, the presently claimed invention is directed to a shaped article obtainable from a polyamide composition comprising:

(A) a polyamide matrix obtained by melt-blending
(a) a polyamide containing repeating units of formula (I)

—[NH—R₁—NH—OC—R₂—CO]— (I)
and/or
(b) a polyamide containing repeating units of formula (II)

—[NH—R₃—CO]— (II)
with
(c) a multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   and
      (B) a fibrous filler material,
      wherein the multifunctional compound is 1,2,4,5-benzenetetracarboxylic acid and/or 1,2,4,5-benzenetetracarboxylic dianhydride.

In another aspect, the presently claimed invention is directed to a process for preparing the above-mentioned shaped article, said process comprising at least the step of extruding in an extrusion device the polyamide composition comprising:

(A) polyamide matrix obtained by melt-blending
(a) polyamide containing repeating units of formula (I)

—[NH—R₁—NH—OC—R₂—CO]— (I)
and/or
(b) polyamide containing repeating units of formula (II)

—[NH—R₃—CO]— (II)
with
(c) multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
      (B) fibrous filler material,
and molding the polyamide composition,
wherein the polyamide containing repeating units of formula (I) and/or (II) is melt-blended with the multifunctional compound in the extrusion device to obtain the polyamide matrix and the fibrous filler material is added during or after obtaining the said polyamide matrix.

In yet another aspect, the presently claimed invention is directed to a polyamide composition comprising:

(A) a polyamide matrix obtained by melt-blending
(a) a polyamide containing repeating units of formula (I)

—[NH—R₁—NH—OC—R₂—CO]— (I)
or
(b) a polyamide containing repeating units of formula (II)

—[NH—R₃—CO]— (II)
with
(c) a multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
      (B) a fibrous filler material.

In still another aspect, the presently claimed invention is directed to a process for preparing the above-mentioned polyamide composition, said process comprising at least the step of extruding in an extrusion device the following:

(A) polyamide matrix obtained by melt-blending
(a) polyamide containing repeating units of formula (I)

—[NH—R₁—NH—OC—R₂—CO]— (I)
or
(b) polyamide containing repeating units of formula (II)

—[NH—R₃—CO]— (II)
with
(c) multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
      (B) fibrous filler material,
and molding the polyamide composition,
wherein the polyamide containing repeating units of formula (I) and/or (II) is melt-blended with the multifunctional compound in the extrusion device to obtain the polyamide matrix and the fibrous filler material is added during or after obtaining the said polyamide matrix.

In yet another aspect, the presently claimed invention is directed to a shaped article obtainable from the above-mentioned polyamide composition.

In another aspect, the presently claimed invention is directed to the use of the above-mentioned polyamide composition in an electrical connector.

In still another aspect, the presently claimed invention is directed to an electrical connector comprising the above-mentioned polyamide composition.

### BRIEF DESCRIPTION OF THE FIGURE

FIG. 1 is the Size Exclusion Chromatography with Multi-Angle Light Scattering (SEC MALS) for the polyamide composition.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to the applicable law.

### Shaped Article

An aspect of the present invention is embodiment 1, directed to a shaped article obtainable from a polyamide composition comprising:

(A) a polyamide matrix obtained by melt-blending
(a) a polyamide containing repeating units of formula (I)

—[NH—R₁—NH—OC—R₂—CO]— (I)
and/or
(b) a polyamide containing repeating units of formula (II)

—[NH—R₃—CO]— (II)
with
(c) a multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   and
      (B) a fibrous filler material,
wherein the multifunctional compound is 1,2,4,5-benzenetetracarboxylic acid and/or 1,2,4,5-benzenetetracarboxylic dianhydride.

In an embodiment, the shaped article can be of any shape, size, dimension and/or geometry and the present invention is not limited by the choices and selection of such shape, size, dimension and/or geometry. Depending on the application of the polyamide composition, the shape, size, dimension and/or geometry may vary. However, in one embodiment, the shaped article is a thin wall connector. Thin wall connectors have reduced wall sections and are widely used for connecting two segments. It has been found that the polyamide composition in the embodiment 1 can be advantageously used for obtaining shaped articles having very thin sections such as, but not limited to, molded articles for application in electrical industry. Suitable examples of shaped articles include, such as but not limited to, cable ties, electrical connectors, valves, electronic or electrical keys, fasteners, clamps and clips.

In one embodiment, the shaped article in the embodiment 1 is obtained by molding the polyamide composition. Suitable molding techniques are well known to the person skilled in the art. For instance, insert molding can be used for obtaining the shaped article. The insert molding technique requires a plastic or polymer material to be injected in a suitable mold wherein an insert or a substrate is already placed. The result of insert molding is a single molded plastic piece with the insert surrounded by the polymer.

### Insert or Substrate

In one embodiment, the shaped article in the embodiment 1 comprises a substrate which is insert molded by the polyamide composition. In the present context, the substrate is alternatively also referred as an insert. The substrate can be any suitable material known to the person skilled in the art and selected based on the intended use of the shaped article. However, in an embodiment, the substrate comprises at least one metallic layer. The term “metallic layer” refers to a layer made of metal. Suitable metals include electrically conductive materials, such as but not limited to, silver, copper and gold. The layer can be of any suitable thickness and length known to the person skilled in the art.

In another embodiment, the substrate in the embodiment 1 can have more than one metallic layers, for e.g. 2, 3, 4, or 5. It is also possible that there are layers of other material present along with the metallic layer.

### Polyamide Composition

In an embodiment, the polyamide composition in the embodiment 1 comprises:

(A) a polyamide matrix obtained by melt-blending
(a) a polyamide containing repeating units of formula (I)

—[NH—R₁—NH—OC—R₂—CO]— (I)
and/or
(b) a polyamide containing repeating units of formula (II)

—[NH—R₃—CO]— (II)
with
(c) a multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   and
      (B) a fibrous filler material,
wherein the multifunctional compound is 1,2,4,5-benzenetetracarboxylic acid and/or 1,2,4,5-benzenetetracarboxylic dianhydride.

In one embodiment, the polyamide composition can be molded in a mold capable of providing thin sections. The substrate can be appropriately placed in the mold and thereafter molded with the polyamide composition to obtain the shaped article. Injection molding is one such technique for molding the substrate with the polyamide composition layer and obtaining the shaped article in the embodiment 1.

The polyamide composition comprises the polyamide matrix and the fibrous filler material. The polyamide matrix is obtained by melt-blending (a) the polyamide containing repeating units of formula (I) and/or (b) the polyamide containing repeating units of formula (II), with the multifunctional compound comprising four identical reactive functions.

In one embodiment, the polyamides having repeating units of formula (I) and (II) are both subject to melt-blending. In another embodiment, the polyamide having repeating units of formula (I) or (II) alone is subject to melt-blending.

In an embodiment, in the polyamide having repeating units of formula (I), R₁ and R₂, independent of each other, are hydrocarbon radicals containing 1 to 20 carbon atoms and optionally containing hetero atoms. The term “hetero atom” refers to an atom other than carbon and hydrogen. Exemplary hetero atoms include, such as but not limited to, oxygen and nitrogen. In another embodiment, the polyamide having repeating units of formula (I) does not contain any hetero atom.

In another embodiment, R₁ and R₂, independent of each other, are hydrocarbon radicals containing 1 to 10 carbon atoms and optionally containing hetero atoms in the embodiment 1. In yet another embodiment, R₁ and R₂, independent of each other, are hydrocarbon radicals containing 1 to 6 carbon atoms and optionally containing hetero atoms. In still another embodiment, R₁ contains 6 carbon atoms, while R₂ contains 4 carbon atoms.

In an embodiment, the polyamide having repeating units of formula (I) in the embodiment 1 is selected from polyamide 6.6, polyamide 6.12, polyamide 4.6, polyamide 6.10, polyamide 6.36 and blends and copolymers thereof. In another embodiment, the polyamide having repeating units of formula (I) is selected from polyamide 6.6, polyamide 6.12, polyamide 4.6 and polyamide 6.10. In yet another embodiment, the polyamide having repeating units of formula (I) is polyamide 6.6.

In an embodiment, in the polyamide having repeating units of formula (II), R₃ is a hydrocarbon radical containing 1 to 20 carbon atoms and optionally containing hetero atoms. In another embodiment, the polyamide having repeating units of formula (II) in the embodiment 1 does not contain any hetero atom.

In another embodiment, R₃ is a hydrocarbon radical containing 1 to 10 carbon atoms and optionally containing hetero atoms. In still another embodiment, R₃ is a hydrocarbon radical containing 1 to 6 carbon atoms and optionally containing hetero atoms. In yet another embodiment, R₃ contains 5 carbon atoms.

In one embodiment, the polyamide having repeating units of formula (II) is selected from polyamide 6, polyamide 11, polyamide 12 and blends and copolymers thereof. In another embodiment, the polyamide having repeating units of formula (II) is polyamide 6.

In another embodiment, the multifunctional compound in the embodiment 1 comprises at least one aromatic ring. The multifunctional compound can have more than one aromatic ring as well, for example 2, 3, 4 or 5. It is also possible that the aromatic rings are fused together. The term “fused” refers to the aromatic rings having two carbon atoms in common.

In another embodiment, the multifunctional compound in the embodiment 1 comprises four identical reactive functions selected from carboxylic acid and derivatives thereof. The term “reactive function” refers to functional groups capable of reacting with the polyamides containing repeating units of formula (I) and (II). Said otherwise, the multifunctional compound reacts with the polyamides containing repeating units of formula (I) and (II), thereby forming a branched structure. The reaction or fusion brought about by the multifunctional compound results in a reduction in melt temperature of the polyamide matrix. The melt temperature provides for a crude estimation of the cycle time. Lowering the melt temperature would result in a shorter cycle time during injection molding and vice versa.

Moreover, since the polyamide matrix is melt flowable due to the multifunctional compound, the injection pressure is also reduced. This also contributes to the cycle time being further reduced, which, in turn, provides for a considerable increase in the productivity of the injection molding process.

The present invention also does not negatively affect the injection molding machine or apparatus because the melt flowable polyamide matrix is capable of being processed at lower melt temperatures and requires considerably lower injection pressure, resulting in lesser tool wear and maintenance requirement of the injection molding machine or apparatus. This further means that the press size will be lesser than that required for processing of a conventional polyamide matrix. The press size specifies the amount of clamping force the machine can apply to keep the mold closed during injection. Since the polyamide composition is melt flowable at lower temperatures, it can be used for making thin wall connectors, which are smaller and thinner in terms of their dimensions. Therefore, the press size required for making the shaped article will be smaller than the conventional ones.

In one embodiment, the multifunctional compound in the embodiment 1 consists of four identical carboxylic acid groups. In another embodiment, the multifunctional compound in the embodiment 1 comprises 1,2,4,5-benzenetetracarboxylic acid, also known as pyromellitic acid.

In other embodiment, the multifunctional compound in the embodiment 1 comprises carboxylic acid derivatives. Suitable carboxylic acid derivatives include, such as but not limited to, carboxylates (deprotonated carboxylic acids), amides, esters, thioesters, acyl phosphates, anhydrides and acyl chlorides. In one embodiment, the multifunctional compound in the embodiment 1 includes a pyromellitic acid derivative, as described herein. Suitable pyromellitic acid derivatives include pyromellitic acid dianhydride.

In an embodiment, the multifunctional compound in the embodiment 1 is 1,2,4,5-benzenetetracarboxylic acid and/or 1,2,4,5-benzenetetracarboxylic dianhydride. In one embodiment, the multifunctional compound in the embodiment 1 is 1,2,4,5-benzenetetracarboxylic acid. In another embodiment, the multifunctional compound in the embodiment 1 is 1,2,4,5-benzenetetracarboxylic dianhydride. In yet another embodiment, the multifunctional compound in the embodiment 1 is a mixture of 1,2,4,5-benzenetetracarboxylic acid and 1,2,4,5-benzenetetracarboxylic dianhydride.

For obtaining the polyamide matrix in the embodiment 1, the multifunctional compound is added in an amount in between 0.1 wt.-% to 10.0 wt.-%, based on the total weight of the polyamide composition. In another embodiment, it is present in between 0.1 wt.-% to 9.0 wt.-%, or in between 0.2 wt.-% to 9.0 wt.-%, or in between 0.2 wt.-% to 8.0 wt.-%, or in between 0.3 wt.-% to 8.0 wt.-%. In another embodiment, it is present in between 0.3 wt.-% to 7.0 wt.-%, or in between 0.4 wt.-% to 7.0 wt.-%, or in between 0.4 wt.-% to 6.0 wt.-%, or in between 0.5 wt.-% to 6.0 wt. %, or in between 0.5 wt.-% to 5.0 wt.-%. In yet another embodiment, it is present in between 0.6 wt.-% to 5.0 wt.-%, or in between 0.6 wt.-% to 4.0 wt.-%, or in between 0.7 wt.-% to 4.0 wt.-%, or in between 0.7 wt.-% to 3.0 wt.-%, or in between 0.8 wt.-% to 3.0 wt.-%, or in between 0.8 wt.-% to 2.0 wt.-%, or in between 0.8 wt.-% to 1.5 wt.-%.

In an embodiment, the polyamide composition in the embodiment 1 also comprises a fibrous filler material. Suitable fibrous filler materials are selected from metal fiber, metalized inorganic fiber, metalized synthetic fiber, glass fiber, polyester fiber, polyvinyl alcohol fiber, graphite fiber, carbon fiber, ceramic fiber, mineral fiber, basalt fiber, inorganic fiber, kenaf fiber, jute fiber, flax fiber, hemp fiber, cellulosic fiber, sisal fiber and coir fiber.

In one embodiment, the fibrous filler material is selected from metal fiber, metalized inorganic fiber, metalized synthetic fiber, glass fiber, polyester fiber, polyvinyl alcohol fiber, graphite fiber, carbon fiber, ceramic fiber, mineral fiber, basalt fiber, inorganic fiber, kenaf fiber, jute fiber and flax fiber. In another embodiment, it is selected from metal fiber, metalized inorganic fiber, metalized synthetic fiber, glass fiber, polyester fiber, polyvinyl alcohol fiber, graphite fiber, carbon fiber and ceramic fiber. In still another embodiment, it is selected from metal fiber, metalized inorganic fiber, metalized synthetic fiber, glass fiber and polyester fiber. In yet another embodiment, the fibrous filler material comprises glass fiber. In a further embodiment, the fibrous filler material is glass fiber.

In one embodiment, the fibrous filler material can be subjected to a surface treatment agent. The surface treatment agent is also known as sizing or coupling agent. The fibrous filler material, when subjected to surface treatment agent, further improves the mechanical properties.

Accordingly, in an embodiment, the coupling agent comprises one or more of a silane coupling agent, titanium coupling agent, aluminate coupling agent, urethane coupling agent and epoxy coupling agent. In another embodiment, the coupling agent comprises urethane coupling agent or epoxy coupling agent. Suitable techniques for surface treatment are well known to the person skilled in the art. For instance, any suitable coating process, such as but not limited to, dip coating and spray coating can be employed.

In one embodiment, the urethane coupling agent comprises at least one urethane group. Suitable urethane coupling agents for use in combination polyamides are known to the person skilled in the art, as for instance described in US pub. no. 2018/0282496 incorporated herein by reference. In one embodiment, the urethane coupling agent comprises, for example, a reaction product of an isocyanate, such as but not limited to, m-xylylene diisocyanate (XDI), 4,4′-methylenebis(cyclohexyl isocyanate) (HMDI) or isophorone diisocyanate (IPDI), and a polyester based polyol or a polyether-based polyol.

In another embodiment, the epoxy coupling agent comprises at least one epoxy group. Suitable epoxy coupling agents for use in combination with polyamides are known to the person skilled in the art, as for instance described in US pub. no. 2015/0247025 incorporated herein by reference. In one embodiment, the epoxy coupling agent is selected from aliphatic epoxy coupling agent, aromatic epoxy coupling agent or a mixture thereof. Non-limiting example of aliphatic coupling agent includes a polyether polyepoxy compound having two or more epoxy groups in a molecule and/or polyol polyepoxy compound having two or more epoxy groups in a molecule.

As aromatic coupling agent, a bisphenol A epoxy compound or a bisphenol F epoxy compound can be used.

Suitable amounts of the surface treatment agents are well known to the person skilled in the art. However, in one embodiment, the surface treatment agent can be present in an amount of 0.1 wt.-% to 10.0 wt.-% based on the total weight of the fibrous filler material.

For the purpose of the present invention, the fibrous filler material can be obtained in any shape and size. For instance, the fibrous filler material can be, such as but not limited to, a strand having a lateral and through-plane dimension or a spherical particle having diameter. Moreover, the fibrous filler material can be aligned in any direction relative to the injection direction.

In one embodiment, the fibrous filler material is present in an amount in between 10 wt.-% to 80 wt.-%, based on the total weight of the polyamide composition. In another embodiment, it is present in between 10 wt.-% to 75 wt.-%, or in between 15 wt.-% to 75 wt.-%, or in between 15 wt.-% to 70 wt.-%, or in between 20 wt.-% to 70 wt.-%, or in between 20 wt.-% to 65 wt.-%, or in between 25 wt.-% to 65 wt.-%. In still another embodiment, it is present in between 25 wt.-% to 60 wt.-%, or in between 25 wt.-% to 55 wt.-%, or in between 25 wt.-% to 50 wt.-%, or in between 30 wt.-% to 50 wt.-%, or in between 30 wt.-% to 45 wt.-%, or in between 30 wt.-% to 40 wt.-%.

In another embodiment, the polyamide composition further comprises at least one additive. These additives are selected from plasticizers, antioxidants, stabilizers, nucleating agents, dyes, pigments, flame retardants, lubricants, UV absorbers, antistats, fungistats, bacteriostats, IR absorbing materials, surfactants, hydrolysis controlling agents, wollastonite stabilizers and resilience modifiers. Suitable amounts of these additives can be added to the polyamide composition. In one embodiment, the additive is present in an amount in between 0.1 wt.-% to 10 wt.-% based on the total weight of the polyamide composition.

The polyamide composition in the embodiment 1 can be obtained using suitable techniques. For instance, the melt blending of the polyamide containing repeating units of formula (I) and/or (II) with the multifunctional compound can be carried out in an extrusion device. In one embodiment, the fibrous filler material can be added in the extrusion device. In another embodiment, the fibrous filler material can be added directly at the time of injection molding to obtain the shaped article.

In one embodiment, the polyamide composition in the embodiment 1 results in low branching or crosslinking, i.e. no or very low star shaped configuration is observed. Unlike U.S. Pat. No. 6,525,166 B1, wherein the formation of star-shaped configuration in the polymer was optimized but not completely avoided, the present invention confirms the absence of any star-shaped configuration in the polyamide composition. The present invention observes absence or very little (in fact, negligible) formation of star-shaped configuration using gel permeation techniques (GPC). In particular, use of Size Exclusion Chromatography with Multi-Angle Light Scattering (SEC MALS) is made. At the same molecule size, branched or star shaper molecules show higher absolute molar mass, i.e., branching makes molecules more compact. Molar mass and size information are required to determine and characterize branching in polymers. Combination of size exclusion chromatography (SEC) and multi angle light scattering (MALS) detector can provide molecule size and absolute molar mass information. This enables the identification of branched or star shaped molecules from linear ones, thereby determining and characterizing the branching in polydisperse branched polymers.

The polyamide composition in the embodiment 1 is melt flowable, can be processed at lower injection pressure, thereby resulting in a reduced cycle time and press size, increase in productivity and reduction in tool wear and maintenance. Further, the polyamide composition also imparts acceptable mechanical properties, particularly tensile, elongation and impact strength, and reduced cooling temperature, which further reduces the cycle time and adds up to the productivity. The shaped article, thus obtained, has thinner dimensions owing to the polyamide composition and therefore, it can be used for obtaining thin wall connectors, such as electrical connectors.

In one embodiment, the shaped article with thickness ranging between 0.1 mm to 5.0 mm can be obtained with the polyamide composition, as described herein. Applications which require such thin dimensions include, such as but not limited to, cable ties, electrical connectors, valves, electronic or electrical keys, fasteners, clamps and clips.

### Process for Preparing Shaped Article

Another aspect of the present invention is embodiment 2, directed to a process for preparing the shaped article, said process comprising at least the step of extruding in an extrusion device the polyamide composition comprising the polyamide matrix and the fibrous filler material, as described herein and molding the polyamide composition, wherein the polyamide containing repeating units of formula (I) and/or (II) is melt-blended with the multifunctional compound in the extrusion device to obtain the polyamide matrix and the fibrous filler material is added during or after obtaining the said polyamide matrix.

In the present context, “extrusion” refers to reactive extrusion. As is known to the person skilled in the art, reactive extrusion and polymerization are two different techniques for general polymer synthesis. Polymerization has been extensively used in the state of the art, for instance in U.S. Pat. No. 6,525,166 B1 for preparing high molecular weight and highly crosslinked or star shaped configuration of the polymer. Due to large residence time of the reactants in the polymerization process, the resulting polymer contains macromolecular chains having star shaped configuration. On the other hand, the present invention reactive extrusion technique is relatively quicker and the extent of polymerization or prevention of star shaped configuration in the polymer is controlled by optimizing throughput, length of the extruder, screw design and speed. The reactive extrusion can be carried out using suitable extrusion devices known to the person skilled in the art.

In one embodiment, the polyamide matrix is first obtained in the extrusion device and the fibrous filler material is added during or after obtaining the said polyamide matrix. Suitable extrusion devices for obtaining thermoplastics are well known to the person skilled in the art. For instance, the extrusion device can be a twin screw or a single screw extruder. In one embodiment, the fibrous filler material is added to the melt-blended polyamide matrix in the extrusion device itself.

Once the polyamide composition or the polyamide matrix is extruded, it is subjected to injection molding. In one embodiment, the fibrous filler material is added to the extruded polyamide matrix during injection molding and thereafter, injected in a suitable mold to obtain the shaped article. Suitable temperature is provided to the injection molding apparatus to enable the extruded polyamide composition or polyamide matrix to melt and thereafter, injected in the mold. One such injection molding apparatus and the process is described hereinbelow.

As is known to the person skilled in the art, injection molding mostly has four elements, viz. molder, material, injection machine and mold. Of these four, injection machine and the mold are the most varied and mechanically diverse. Most injection machines have three platens. Alternatively, there may be just two platens, which are electrically operated as opposed to the traditional hydraulic models. They can range in size from table top models to some of a small house. Although, most of these machines function horizontally, vertical models can also be used. All injection machines are built around an injection system and a clamping system. The injection system mechanism may be of the reciprocating screw type or, less frequently, the two-stage screw type. Also included is a hopper, a heated injection barrel encasing the screw, a hydraulic motor and an injection cylinder. The machine functions by heating the extruded polyamide composition or polyamide matrix and injected into the mold. As the polyamide composition/matrix enters the injection barrel, it is moved forward by the rotation of the screw. As this movement occurs, the polyamide composition or polyamide matrix is melted by frictional heat and supplementary heating of the barrel encasing the screw. The screw has three distinct zones which further processes the polyamide composition or polyamide matrix to actual injection. In case of polyamide matrix being fed to the machine, the fibrous filler material is also fed subsequently.

Injection is accomplished through an arrangement of valves and a nozzle, all acted upon by the screw and the hydraulic pump that pushes the polyamide composition or the polyamide matrix into the mold. A temperature in the range of 230° C. to 350° C. prevails until the injection of the polyamide composition or polyamide matrix is done into the mold. For example, the injection molding can be carried out at a barrel temperature of 20° C. above the melt temperature of the polyamide composition or the polyamide matrix. The melt temperature of the polyamide composition or the polyamide matrix typically ranges between 220° C. to 260° C.

The clamping system's function is to keep the plastic from leaking out or “flashing” at the mold's parting line. The clamping system consists of a main hydraulic pressure acting on the mold platens and a secondary toggle action to maximize the total clamping pressure. All injection machines have some sort of safety interlock that prevent access to the molds during the clamping and injection phases when the machine is operated semi-automatically. The operator removes the finished part, closes the door or gate, which sets in motion the next molding cycle. In full automatic operation, finished parts fall into a container, conveyor or are removed by robot mechanisms.

The mold determines the final shape of the article, acts as a heat sink to cool the part, is made to vent trapped air and gases and finally ejects the finished shaped article. Molds are most often made of special molding steel. Other mold materials include, such as but not limited to, beryllium copper, stainless steel, aluminum, brass, and Kirksite. These molds are manufactured by machining, EDM, or casting. The finished mold surfaces are often polished and coated to resist wear and air in part ejection. The accurate mounting of each half of the mold is accomplished with leader pins and dowels and ensures proper mold alignment. These molds may have several and varied types of runners and gates. The function of the runners is to channel the flowing polyamide composition or the polyamide matrix the mold's gates, which in turn lead to the cavity itself. In some cases where the polyamide composition or the polyamide matrix goes directly into the cavity, it goes through a “sprue gate”. Vents are ground on the molds parting line to allow the escape of air and gasses as the mold fills. The “molder” determines the size, number and location of the vents according to the parts geometry, gate locations, type and viscosity of the polyamide composition or the polyamide matrix, and the injection rate. The mold also has an internal water cooling network. Cooling contributes to controlled shrinkage, part strength and process speed. When the mold opens, part ejection is accomplished by pins and bushings pneumatically or hydraulically actuated. Older machines use mechanical systems, while still others use a stripper plate arrangement.

Further, the machine control may range from electromagnetic relays and timers to computer driven solid state devices. Computers not only control the process sequences, but also perform quality control functions, real-time reject recognition, fault analysis, record keeping and instant set procedures.

Another aspect of the present invention is embodiment 3, directed to a polyamide composition comprising:

(A) a polyamide matrix obtained by melt-blending
(a) a polyamide containing repeating units of formula (I)

—[NH—R₁—NH—OC—R₂—CO]— (I)
or
(b) a polyamide containing repeating units of formula (II)

—[NH—R₃—CO]— (II)
with
(c) a multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride
   and
      (B) a fibrous filler material.

Embodiments pertaining to the polyamide matrix and the fibrous filler material have already been described in embodiment 1. The polyamide composition in the embodiment 3 comprises the polymer matrix and the fibrous filler, as described herein, however, the polyamide matrix in the embodiment 3 is obtained by melt-blending the polyamide containing repeating units of formula (I) or (II) with the multifunctional compound only.

### Process for Preparing the Polyamide Composition

Another aspect of the present invention is embodiment 4, directed to a process for preparing the polyamide composition in the embodiment 3, said process comprising at least the step of extruding in an extrusion device the polyamide composition comprising the polyamide matrix and the fibrous filler material, wherein the polyamide containing repeating units of formula (I) or (II) is melt-blended with the multifunctional compound in the extrusion device to obtain the polyamide matrix and the fibrous filler material is added during or after obtaining the said polyamide matrix. Embodiments pertaining to the process for preparing the polyamide composition have already been described in embodiment 2.

### Shaped Article

Another aspect of the present invention is embodiment 5, directed to a shaped article obtainable from the polyamide composition of the embodiment 3 or as obtained in the embodiment 4.

In one embodiment, the shaped article in the embodiment 5 is selected from cable ties, electrical connectors, valves, electronic or electrical keys, fasteners, clamps and clips. In another embodiment, the shaped article is an electrical connector.

As is known to the person skilled in the art, the electrical connector is an electromechanical device used to join electrical terminations and create and electrical circuit. Most electrical connectors have a gender, i.e. a male component called a plug, which connects to a female component, called socket. The connection may be removable, as for portable equipment, require a tool for assembly and removal, or serve as a permanent electrical joint between two points. An adapter can be used to join dissimilar connectors. The electrical connectors can be divided into four basic categories, differentiated by their function: (i) inline or cable connectors, which are permanently attached to a cable, allowing it to be plugged into another terminal (either a stationary instrument or another cable), (ii) chassis or panel connectors, which are permanently attached to a piece of equipment, allowing users to connect a cable to a stationary device, (iii) PCB mount connectors soldered to a printed circuit board, providing a point for a cable or wire to be attached, for e.g. pin headers, screw terminals, board-to-board connectors, and (iv) splice or butt connectors or primarily insulation displacement connectors, which permanently join two lengths of wire or cable.

### Use

Another aspect of the present invention is embodiment 6, directed to the use of the polyamide composition of the embodiment 3 or as obtained in the embodiment 4 in electrical connector.

### Electrical Connector

Another aspect of the present invention is embodiment 7, directed to an electrical connector comprising the polyamide composition of the embodiment 3 or as obtained in the embodiment 4. In one embodiment, the electrical connector in the embodiment 7 is an automotive electrical connector. Said otherwise, the electrical connector in the embodiment 7 finds application as in automobiles electrical systems. In another embodiment, the electrical connector in the embodiment 7 is a circuit breaker. For applications requiring additional properties, for e.g. flame retardancy in case of circuit breakers, suitable flame retardants as additives may be added to the polyamide composition, as described herein.

The present invention is illustrated in more detail by the following embodiments and combinations of embodiments which result from the corresponding dependency references and links:
I. A shaped article obtainable from a polyamide composition comprising:
   (A) a polyamide matrix obtained by melt-blending
   (a) a polyamide containing repeating units of formula (I)

—[NH—R₁—NH—OC—R₂—CO]— (I)
and/or
(b) a polyamide containing repeating units of formula (II)

—[NH—R₃—CO]— (II)
with
(c) a multifunctional compound comprising four identical reactive functions selected from carboxylic acid and derivatives thereof,
wherein R₁, R₂ and R₃, independent of each other, being hydrocarbon radicals containing 1 to 20 carbon atoms and optionally containing hetero atoms,
wherein the multifunctional compound is 1,2,4,5-benzenetetracarboxylic acid and/or 1,2,4,5-benzenetetracarboxylic dianhydride
and
(B) a fibrous filler material.
II. The shaped article according to embodiment I, wherein R₁, R₂ and R₃, independent of each other, contain 1 to 10 carbon atoms and optionally contain hetero atoms.
III. The shaped article according to embodiment I or II, wherein R₁, R₂ and R₃, independent of each other, contain 1 to 6 carbon atoms and optionally contain hetero atoms.
IV. The shaped article according to one or more of embodiments I to III, wherein the polyamide containing repeating units of formula (I) is selected from polyamide 6.6, polyamide 6.12, polyamide 4.6, polyamide 6.10, polyamide 6.36 and blends and copolymers thereof.
V. The shaped article according to one or more of embodiments I to IV, wherein the polyamide containing repeating units of formula (I) is polyamide 6.6.
VI. The shaped article according to one or more of embodiments I to III, wherein the polyamide containing repeating units of formula (II) is selected from polyamide 6, polyamide 11, polyamide 12 and blends and copolymers thereof.
VII. The shaped article according to one or more of embodiments I to III, wherein the polyamide containing repeating units of formula (II) is polyamide 6.
VIII. The shaped article according to one or more of embodiments I to VII, wherein the multifunctional compound comprises at least one aromatic ring.
IX. The shaped article according to one or more of embodiments I to VIII, wherein the multifunctional compound is 1,2,4,5-benzenetetracarboxylic acid.
X. The shaped article according to one or more of embodiments I to IX, wherein the multifunctional compound is present in an amount in between 0.1 wt.-% to 10.0 wt. %, based on the total weight of the polyamide composition.
XI. The shaped article according to one or more of embodiments I to X, wherein the multifunctional compound is present in an amount in between 0.5 wt.-% to 5.0 wt. %, based on the total weight of the polyamide composition.
XII. The shaped article according to one or more of embodiments I to XI, wherein the fibrous filler material is selected from metal fiber, metalized inorganic fiber, metalized synthetic fiber, glass fiber, polyester fiber, polyvinyl alcohol fiber, graphite fiber, carbon fiber, ceramic fiber, mineral fiber, basalt fiber, inorganic fiber, kenaf fiber, jute fiber, flax fiber, hemp fiber, cellulosic fiber, sisal fiber and coir fiber.
XIII. The shaped article according to one or more of embodiments I to XII, wherein the fibrous filler material comprises glass fiber.
XIV. The shaped article according to one or more of embodiments I to XIII, wherein the fibrous filler material is present in an amount in between 10 wt.-% to 80 wt.-%, based on the total weight of the polyamide composition.
XV. The shaped article according to one or more of embodiments I to XIV, wherein the fibrous filler material is present in an amount in between 30 wt.-% to 50 wt.-%, based on the total weight of the polyamide composition.
XVI. The shaped article according to one or more of embodiments I to XV, further comprising at least one additive.
XVII. The shaped article according to embodiment XVI, wherein the additive is selected from plasticizers, antioxidants, stabilizers, nucleating agents, dyes, pigments, flame retardants, lubricants, UV absorbers, antistats, fungistats, bacteriostats, IR absorbing materials, surfactants, hydrolysis controlling agents, wollastonite stabilizers and resilience modifiers.
XVIII. The shaped article according to one or more of embodiments I to XVII, wherein the shaped article is an electrical connector.
XIX. A process for preparing a shaped article according to one or more of embodiments I to XVIII, said process comprising at least the step of extruding in an extrusion device the polyamide composition comprising:
   (A) polyamide matrix obtained by melt-blending
      (a) polyamide containing repeating units of formula (I)

—[NH—R₁—NH—OC—R₂—CO]— (I)
and/or
(b) polyamide containing repeating units of formula (II)

—[NH—R₃—CO]— (II)
with
(c) multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
(B) fibrous filler material,
   and molding the polyamide composition,
   wherein the polyamide containing repeating units of formula (I) and/or (II) is melt-blended with the multifunctional compound in the extrusion device to obtain the polyamide matrix and the fibrous filler material is added during or after obtaining the said polyamide matrix.
XX. A polyamide composition comprising:
   (A) a polyamide matrix obtained by melt-blending
      (a) a polyamide containing repeating units of formula (I)

—[NH—R₁—NH—OC—R₂—CO]— (I)
or
(b) a polyamide containing repeating units of formula (II)

—[NH—R₃—CO]— (II)
with
(c) a multifunctional compound comprising at least three reactive functions selected from amines, carboxylic acids and derivatives thereof,
   wherein the reactive functions are identical and R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
(B) a fibrous filler material.
XXI. The polyamide composition according to embodiment XX, wherein R₁, R₂ and R₃, independent of each other, contain 1 to 10 carbon atoms and optionally contain hetero atoms.
XXII. The polyamide composition according to embodiment XX or XXI, wherein R₁, R₂ and R₃, independent of each other, contain 1 to 6 carbon atoms and optionally contain hetero atoms.
XXIII. The polyamide composition according to one or more of embodiments XX to XXII, wherein the polyamide containing repeating units of formula (I) is selected from polyamide 6.6, polyamide 6.12, polyamide 4.6, polyamide 6.10, polyamide 6.36 and blends and copolymers thereof.
XXIV. The polyamide composition according to one or more of embodiments XX to XXIII, wherein the polyamide containing repeating units of formula (I) is polyamide 6.6.
XXV. The polyamide composition according to one or more of embodiments XX to XXIV, wherein the polyamide containing repeating units of formula (II) is selected from polyamide 6, polyamide 11, polyamide 12 and blends and copolymers thereof.
XXVI. The polyamide composition according to one or more of embodiments XX to XXV, wherein the polyamide containing repeating units of formula (II) is polyamide 6.
XXVII. The polyamide composition according to one or more of embodiments XX to XXVI, wherein the multifunctional compound comprises at least one aromatic ring.
XXVIII. The polyamide composition according to one or more of embodiments XX to XXVII, wherein the multifunctional compound is 1,2,4,5-benzenetetracarboxylic acid.
XXIX. The polyamide composition according to one or more of embodiments XX to XXVIII, wherein the multifunctional compound is present in an amount in between 0.1 wt.-% to 10.0 wt.-%, based on the total weight of the polyamide composition.
XXX. The polyamide composition according to one or more of embodiments XX to XXIX, wherein the multifunctional compound is present in an amount in between 0.1 wt.-% to 5.0 wt.-%, based on the total weight of the polyamide composition.
XXXI. The polyamide composition according to one or more of embodiments XX to XXX, wherein the fibrous filler material is selected from metal fiber, metalized inorganic fiber, metalized synthetic fiber, glass fiber, polyester fiber, polyvinyl alcohol fiber, graphite fiber, carbon fiber, ceramic fiber, mineral fiber, basalt fiber, inorganic fiber, kenaf fiber, jute fiber, flax fiber, hemp fiber, cellulosic fiber, sisal fiber and coir fiber.
XXXII. The polyamide composition according to one or more of embodiments XX to XXXI, wherein the fibrous filler material comprises glass fiber.
XXXIII. The polyamide composition according to one or more of embodiments XX to XXXII, wherein the fibrous filler material is present in an amount in between 10 wt.-% to 80 wt.-%, based on the total weight of the polyamide composition.
XXXIV. The polyamide composition according to one or more of embodiments XX to XXXIII, wherein the fibrous filler material is present in an amount in between 30 wt.-% to 50 wt.-%, based on the total weight of the polyamide composition.
XXXV. The polyamide composition according to one or more of embodiments XX to XXXIV, further comprising at least one additive.
XXXVI. The polyamide composition according to embodiment XXXV, wherein the additive is selected from plasticizers, antioxidants, stabilizers, nucleating agents, dyes, pigments, flame retardants, lubricants, UV absorbers, antistats, fungistats, bacteriostats, IR absorbing materials, surfactants, hydrolysis controlling agents, wollastonite stabilizers and resilience modifiers.
XXXVII. A process for preparing a polyamide composition according to one or more of embodiments XX to XXXVI, said process comprising at least the step of extruding in an extrusion device the following:
   (A) polyamide matrix obtained by melt-blending
      (a) polyamide containing repeating units of formula (I)

—[NH—R₁—NH—OC—R₂—CO]— (I)
or
(b) polyamide containing repeating units of formula (II)

—[NH—R₃—CO]— (II)
with
(c) multifunctional compound comprising four identical reactive functions selected from carboxylic acid and derivatives thereof,
   wherein R₁, R₂ and R₃, independent of each other, being hydrocarbon radicals containing 1 to 20 carbon atoms and optionally containing hetero atoms,
   wherein the multifunctional compound is 1,2,4,5-benzenetetracarboxylic acid and/or 1,2,4,5-benzenetetracarboxylic dianhydride,
   and
(B) fibrous filler material,
   wherein the polyamide containing repeating units of formula (I) or (II) is melt-blended with the multifunctional compound in the extrusion device to obtain the polyamide matrix and the fibrous filler material is added during or after obtaining the said polyamide matrix.
XXXVIII. A shaped article obtainable from the polyamide composition according to one or more of embodiments XX to XXXVI or as obtained by the process according to embodiment XXXVII.
XXXIX. The shaped article according to embodiment XXXVIII, wherein the shaped article is selected from cable ties, electrical connectors, valves, electronic or electrical keys, fasteners, clamps and clips.
XL. The shaped article according to one or more of embodiments XXXVIII or)(XXIX, wherein the shaped article is an electrical connector.
XLI. Use of the polyamide composition according to one or more of embodiments XX to XXXVI or as obtained by the process according to embodiment XXXVII in an electrical connector.
XLII. An electrical connector comprising the polyamide composition according to one or more of embodiments XX to XXXVI or as obtained by the process according to embodiment XXXVII.
XLIII. The electrical connector according to embodiment XLII, wherein the electrical connector is an automotive electrical connector.
XLIV. The electrical connector according to embodiment XLIII, wherein the electrical connector is a circuit breaker.

### EXAMPLES

The presently claimed invention is illustrated by the non-restrictive examples which are as follows:

### Compounds

| | |
|---|---|
| Polyamide | Polyamide 6.6, obtained from BASF |
| Multifunctional compound | 1,2,4,5-benzenetetracarboxylic acid, |
| | obtained from Sigma Aldrich |
| Fibrous filler material | Glass fiber |

### Standard Method

| | |
|---|---|
| Melt flow rate | ISO 1133 |
| Tensile properties (modulus, stress at | ISO 527 |
| break and strain at break) | |
| Izod notched impact strength | ISO 180 |
| Heat deflection temperature (HDT) | ISO 75 |

### General Synthesis of Polyamide Composition

Polyamide 6.6 was melt blended with 1,2,4,5-benzenetetracarboxylic acid at a temperature profile ranging from 260° C. to 310° C. using a twin screw compounder. Glass fiber was added using a second feeder into one of the extruder feed zones on the barrel.

The inventive formulation was compared with commercially available grades. The results are summarized in Table 1 below. All amounts in wt.-%.

TABLE 1
Inventive and comparative polyamide composition

| Ingredient | IE 1 | IE 2 | CE 1 | CE 2 |
|---|---|---|---|---|
| Polyamide 6.6 | 64 | 63.5 | Ultramid ® | Ultramid ® |
| Multifunctional | 1.0 | 1.5 | A3EG7* (no | A3EG7 HP^{#} (no |
| compound | | | multifunctional | multifunctional |
| Glass fiber | 35 | 35 | compound) | compound) |

Properties of the polyamide composition

| | | | | |
|---|---|---|---|---|
| Melt flow rate | 105.3 | 152.9 | 27.34 | 53.5 |
| (g/10 min) at 275° C. | | | | |
| Tensile modulus | 11674 | 11684 | 11128 | 11491 |
| (MPa) | | | | |
| Stress at break | 205.4 | 195.8 | 208 | 210 |
| (MPa) | | | | |
| Strain at break | 2.45 | 2.21 | 3.05 | 2.75 |
| (%) | | | | |
| HDT | 264/254 | 264/254 | 262/253 | 261/252 |
| (0.45 MPa/1.8 MPa) | | | | |
| Izod notched strength | 10.5 | 11.6 | 11.6 | 10.6 |
| (23° C., kJ/m²) | | | | |

*commercially available polyamide 6.6 containing 35 wt.-% glass fiber grade from BASF
^{#}commercially available polyamide 6.6 containing 35 wt.-% glass fiber high productivity grade obtained from BASF

### Spiral Flow Test

The inventive and comparative compositions were subjected to spiral flow test. The spiral flow test measures the rheological behaviour or flow behaviour in a spiral flow at varying molding pressures. In this test, sample is injected into a spiral flow mold at various pressures and flow length is measured as a measure of flowability. The higher the flow length, the better the flowability. The test results are summarized in Table 2 below.

TABLE 2
Spiral flow test results for inventive and comparative compositions

| Sample | Injection pressure (psi) | Spiral flow length (cm) |
|---|---|---|
| IE 1 | 500 | 76 |
| | 1000 | 112 |
| | 1500 | Could not be measured* |
| IE 2 | 500 | 90 |
| | 1000 | Could not be measured* |
| | 1500 | Could not be measured* |
| CE 1 | 500 | 49 |
| | 1000 | 72 |
| | 1500 | 91 |

*Exceeded the max flow length of 117 cm

### Molding Trial

The inventive and comparative polyamide compositions were subjected to injection molding to obtain connectors having dimensions 18 mm×18 mm×12 mm. The compositions were subjected to different injection speed and injection pressure. The results are summarized in Table 3 below.

TABLE 3
Injection speed and pressure values for
inventive and comparative compositions

| Sample | Injection pressure (MPa) | Injection speed (inch/s) |
|---|---|---|
| IE 1 | 81.70 | 0.39 |
| | 81.34 | 0.78 |
| | 90.32 | 1.57 |
| | 98.59 | 2.35 |
| | 106.18 | 3.13 |
| | 111.0 | 3.94 |
| IE 2 | 62.05 | 0.39 |
| | 61.36 | 0.78 |
| | 66.19 | 1.57 |
| | 74.46 | 2.35 |
| | 81.36 | 3.13 |
| | 86.18 | 3.94 |
| CE 1 | 118.59 | 0.39 |
| | 115.14 | 0.78 |
| | 126.17 | 1.57 |
| | 135.48 | 2.35 |
| | 145.48 | 3.13 |
| | 151.68 | 3.94 |

As evident above, the inventive composition results in substantial reduction in the injection pressure. In fact, for IE 2 the injection pressure required was almost half of that of CE 1. The significantly less injection pressure would result in reduction in the cycle time and therefore, reduced tool wear and maintenance.

### USCAR Test

The inventive and comparative polyamide compositions were subjected to USCAR test with heat cycling at 150° C. for 320 h. Elongation at break and impact strength were measured before and after the test. The results are summarized in Table 4 below.

TABLE 4
USCAR test results for inventive and comparative connectors

| | Strain at break (%) | | Izod notched impact strength (kJ/m²) | |
|---|---|---|---|---|
| Sample | Initial | Final | Initial | Final |
| IE 1 | 2.45 | 2.47 | 10.5 | 9.9 |
| CE 1 | 3.1 | 1.6 | 11.6 | 9.4 |

As observed in Table 4, IE 1 shows similar or better performance in comparison to the standard composition CE 1 (without multifunctional compound).

### SEC MALS Analysis

The polymer was first dissolved in a suitable eluent. The dissolved polymer was then separated on a highly porous column depending on its hydrodynamic volume. Smaller chains elute later than larger chains. The concentration of the polyamide composition was recorded as a function of elution time. With a known flowrate, the elution time was transformed into the elution volume. For the determination of molecular weights, the hydrodynamic volume of a chain was set into relation with its molecular weight using narrowly distributed polymer standards with known molecular weights. The accuracy of the result for a sample depends on the similarity between the sample and the standard used for the calibration.

For the analysis below, hexafluoro isopropanol (with 0.05% trifluoroacetic acid potassium salt) was used as eluent. The temperature was maintained at 35° C., with flow rate of 1 mL/min. The concentration of the polyamide composition was 1.5 mg/mL, with 50 μl of injection volume. The calibration was carried out with closely distributed PMMA standards from PSS with molecular weights ranging between 800 g/mol to 2,200,000 g/mol. The values outside this elution range were extrapolated.

To confirm the absence of any star-shaped configuration in the present invention, IE 3, IE 4 and CE 3 were prepared as outlined above. The polyamide used here was polyamide 6 obtained from BASF as Ultramid® B27, which was modified with suitable amounts of the multifunctional compound. For SEC MALS analysis, no use of fibrous filler material was made as it had no effect on the polymer matrix. The formulation details are summarized in Table 5 below (in wt. %):

TABLE 5
Formulation details for SEC MALS analysis

| Ingredient | IE 3 | IE 4 | CE 3 |
|---|---|---|---|
| Polyamide 6.6 | 99 | 98 | 100 |
| Multifunctional | 1.0 | 3.0 | — |
| compound | | | |
| Mn, g/mol | 15,500 | 11,700 | 18,900 |
| Mw, g/mol | 51,200 | 40,200 | 62,100 |
| Melt flow rate | 426 | 605 | 137 |
| (g/5 min, 2.16 kg) at | | | |
| 275° C. | | | |
| Tensile modulus | 3070 | 2968 | 300 |
| (MPa) | | | |
| Stress at break | 81.4 | 38.8 | 90 |
| (MPa) | | | |
| Strain at break | 3.65 | 1.32 | 4.5 |
| (%) | | | |
| Izod notched strength | 5.1 | 2.2 | 8 |
| (23° C., kJ/m²) | | | |

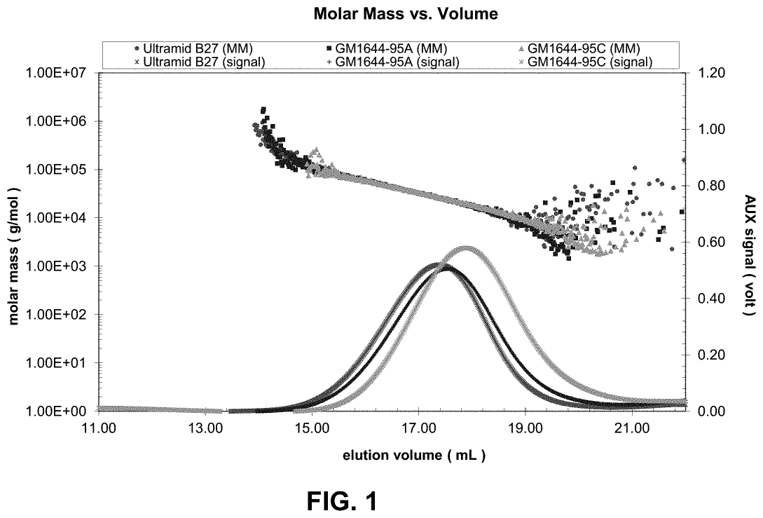

As evident from Table 5, there is a reduction in molecular weight (both Mn and Mw) upon including the multifunctional compound in the polyamide matrix. This confirms the absence of crosslinking or star shaped configuration, rather depicts random polymer chain scission. Additionally, this is also evident in FIG. 1, wherein the slope of the curve for CE 3 overlaps with both IE 3 and IE 4. Ultramid® B27 (CE 3) does not contain any star-shaped configuration, rather a linear structure.

1. A shaped article obtainable obtained from a polyamide composition comprising:
(A) a polyamide matrix obtained by melt-blending
(a) a polyamide containing repeating units of formula (I)
—[NH—R₁—NH—OC—R₂—CO]— (I)
and/or
(b) a polyamide containing repeating units of formula (II)
—[NH—R₃—CO]— (II)
with
(c) a multifunctional compound comprising four identical reactive functions selected from the group consisting of carboxylic acid and derivatives thereof,
wherein R₁, R₂ and R₃, independent of each other, are hydrocarbon radicals containing 1 to 20 carbon atoms and optionally containing hetero atoms,
and
(B) a fibrous filler material,
wherein the multifunctional compound is 1,2,4,5-benzenetetracarboxylic acid and/or 1,2,4,5-benzenetetracarboxylic dianhydride.

2. The shaped article according to claim 1, wherein R₁, R₂ and R₃, independent of each other, contain 1 to 10 carbon atoms and optionally contain hetero atoms.

3. The shaped article according to claim 1, wherein R₁, R₂ and R₃, independent of each other, contain 1 to 6 carbon atoms and optionally contain hetero atoms.

4. The shaped article according to claim 1, wherein the polyamide containing repeating units of formula (I) is polyamide 6.6.

5. The shaped article according to claim 1, wherein the polyamide containing repeating units of formula (II) is polyamide 6.

6. The shaped article according to claim 1, wherein the multifunctional compound is present in an amount in between 0.1 wt.-% to 10.0 wt.-%, based on a total weight of the polyamide composition.

7. The shaped article according to claim 1, wherein the fibrous filler material comprises glass fiber.

8. The shaped article according to claim 1, further comprising at least one additive.

9. The shaped article according to claim 8, wherein the additive is selected from the group consisting of plasticizers, antioxidants, stabilizers, nucleating agents, dyes, pigments, flame retardants, lubricants, UV absorbers, antistats, fungistats, bacteriostats, IR absorbing materials, surfactants, hydrolysis controlling agents, wollastonite stabilizers and resilience modifiers.

10. The shaped article according to claim 1, wherein the shaped article is an electrical connector.

11. The shaped article according to claim 1, wherein the shaped article has a thickness ranging between 0.1 mm to 5 mm.

12. A process for preparing a shaped article according to claim 1, said process comprising at least a step of extruding, in an extrusion device, the polyamide composition comprising:
(A) polyamide matrix obtained by melt-blending
(a) polyamide containing repeating units of formula (I)
—[NH—R₁—NH—OC—R₂—CO]— (I)
and/or
(b) polyamide containing repeating units of formula (II)
—[NH—R₃—CO]— (II)
with
(c) multifunctional compound comprising four identical reactive functions selected from the group consisting of carboxylic acid and derivatives thereof,
wherein R₁, R₂ and R₃, independent of each other, are hydrocarbon radicals containing 1 to 20 carbon atoms and optionally containing hetero atoms,
wherein the multifunctional compound is 1,2,4,5-benzenetetracarboxylic acid and/or 1,2,4,5-benzenetetracarboxylic dianhydride,
and
(B) fibrous filler material,
and molding the polyamide composition,
wherein the polyamide containing repeating units of formula (I) and/or (II) is melt-blended with the multifunctional compound in the extrusion device to obtain the polyamide matrix and the fibrous filler material is added during or after obtaining the said polyamide matrix.

13. A polyamide composition comprising:
(A) a polyamide matrix obtained by melt-blending
(a) a polyamide containing repeating units of formula (I)
—[NH—R₁—NH—OC—R₂—CO]— (I)
or
(b) a polyamide containing repeating units of formula (II)
—[NH—R₃—CO]— (II)
with
(c) a multifunctional compound comprising at least three reactive functions selected from the group consisting of amines, carboxylic acids and derivatives thereof,
wherein the reactive functions are identical and R₁, R₂ and R₃, independent of each other, are hydrocarbon radicals containing 1 to 20 carbon atoms and optionally containing hetero atoms,
wherein the multifunctional compound is 1,2,4,5-benzenetetracarboxylic acid and/or 1,2,4,5-benzenetetracarboxylic dianhydride,
and
(B) a fibrous filler material.

14. A process for preparing a polyamide composition according to claim 13, said process comprising at least a step of extruding, in an extrusion device, the following:
(A) polyamide matrix obtained by melt-blending
(a) polyamide containing repeating units of formula (I)
—[NH—R₁—NH—OC—R₂—CO]— (I)
or
(b) polyamide containing repeating units of formula (II)
—[NH—R₃—CO]— (II)
with
(c) multifunctional compound comprising four identical reactive functions selected from the group consisting of carboxylic acid and derivatives thereof,
wherein R₁, R₂ and R₃, independent of each other, are hydrocarbon radicals containing 1 to 20 carbon atoms and optionally containing hetero atoms,
wherein the multifunctional compound is 1,2,4,5-benzenetetracarboxylic acid and/or 1,2,4,5-benzenetetracarboxylic dianhydride,
and
(B) fibrous filler material,
wherein the polyamide containing repeating units of formula (I) or (II) is melt-blended with the multifunctional compound in the extrusion device to obtain the polyamide matrix and the fibrous filler material is added during or after obtaining the said polyamide matrix.

15. A shaped article obtained from the polyamide composition according to claim 13.

16. The shaped article according to claim 15, wherein the shaped article is selected from the group consisting of cable ties, electrical connectors, valves, electronic or electrical keys, fasteners, clamps and clips.

17. A method of using the polyamide composition according to claim 13 in an electrical connector.

18. An electrical connector comprising the polyamide composition according to claim 13.

19. A shaped article as obtained by the process according to claim 14.

20. An electrical connector comprising the polyamide composition as obtained by the process according to claim 14.
